(19) United States
(12) Patent Application Publication
(10) Pub. No.: US 2005/0229983 A1
(43) Pub. Date: Oct. 20, 2005

(54) Water inlet/outlet structure for ceramic shaft of single-handled faucet

(75) Inventor: Mei-Li Chen, Taipei (TW)

Correspondence Address: TROXELL LAW OFFICE PLLC, SUITE 1404, 5205 LEESBURG PIKE, FALLS CHURCH, VA, 22041, US

(73) Assignee: Kuching International Ltd.

(21) Appl. No.: 10/825,109

(22) Filed: Apr. 16, 2004

(51) Int. Cl. F16K 11/078

(52) U.S. Cl. 137/625.17

(57) ABSTRACT

A water inlet/outlet structure for a ceramic shaft of a single-handled faucet includes a valve housing having a valve chamber disposed therein for a switch valve set and a valve mount to be adapted therein wherein the switch valve set made up of a control stick seat, a support seat and a switch valve is engaged with the valve mount equipped with an upper and lower switch valves. Grooved seats are disposed at the bottom peripheries of arc hot/cold water inlet holes and a water outlet hole of the lower switch valve thereof to be registered with higher protruded walls extending at the peripheries of arc hot/cold water inlet passage and a water outlet passage of the valve mount thereof respectively. A lower stop wall is integrally formed outside the higher protruded walls thereof to define a channel groove there-between for a sealing ring of identical shape to be securely engaged therewith. Thus, when the hot/cold water inlet holes and the water outlet hole of the lower switch valve are overlapped on top of the hot/cold water inlet passages and the water outlet passage of the valve mount respectively, the grooved seats thereof are securely coupled with the higher protruded walls thereof to effect a tight seal against leakage and press downwards the sealing ring, efficiently facilitating the sealing effect of the sealing ring and ensuring the precise engagement of the lower switch valve with the valve mount thereof so as to achieve the purposes of leakage-proof as well as resistance to high water pressure and impact in practical use.

### BACKGROUND OF THE INVENTION

The present invention is related to a water inlet/outlet structure for a ceramic shaft of a single-handled faucet, including a valve housing having a valve chamber disposed at the interior thereof for a switch valve set and a valve mount to be adapted therein wherein the switch valve set having a control stick seat, a support seat and a switch valve sequentially mounted from top to bottom is engaged with the valve mount equipped with an upper and lower switch valves; whereby, in assembly when hot/cold water inlet holes and a water outlet hole of the lower switch valve are overlapped on top of hot/cold water inlet passages and a water outlet passage of the valve mount respectively, grooved seats disposed at the bottom peripheries of the hot/cold water inlet holes and the water outlet hole thereof are securely coupled with higher protruded walls defining the peripheries of the hot/cold water inlet passages and the water outlet passage thereof to effect a tight seal against leakage and press downwards a sealing ring retained at a channel groove defined by the higher protruded walls and a lower stop wall of the valve mount thereof, efficiently facilitating the sealing effect of the sealing ring and ensuring the precise engagement of the lower switch valve with the valve mount thereof so as to achieve the purposes of leakage-proof as well as resistance to high water pressure and impact in use.

Please refer to FIGS. 1 to 2 inclusive. A conventional water inlet/outlet structure for a ceramic shaft of a single-handled faucet is mainly made up of a valve housing 10 having a valve chamber 11 disposed therein for a switch valve set 20 and a valve mount 30 to be retained therein. The switch valve set 20 is provided with a control stick seat 21 disposed at the upper section thereof, and a support seat 22 with a switch valve 23 sequentially mounted at the bottom of the control stick seat 21 thereof to be registered with the valve mount 30 thereby. The valve mount 30 is equipped with an upper switch valve 31 having a regulating recess 311 defining the bottom side thereon, and a lower switch valve 32 having a flat bottom side with a pair of symmetrical arc hot/cold water inlet holes 321, 322 and a water outlet hole 323 disposed thereon to be correspondingly matched to arc hot/cold water inlet passages 301, 302 and a water outlet passage 303 of the valve mount 30 thereof. Protruded rib walls 3011, 3021, 3031 are extending upwards at the periphery of the arc hot/cold water inlet passages 301, 302 and the water outlet passage 303 thereof, and a stop wall 304 of the same height are disposed outside the arc hot/cold water inlet passages 301, 302 and the water outlet passage 303 thereof to define a channel groove 305 there-between for a sealing ring 33 of identical shape to be adapted therein in abutment against the lower switch valve 32 thereof.

There are some drawbacks to such conventional water inlet/outlet structure for a ceramic shaft of a single-handled faucet. Most of all, the protruded rib walls 3011, 3021, 3031 and the stop wall 304 of the valve mount 30 are of the same height, which can simply abut the valve mount 30 against the flat bottom side of the lower switch valve 32 when the lower switch valve 32 is overlapped on top of the valve mount 30 in assembly. Thus, the sealing ring 33 adapted at the valve mount 30 therein can only abut against the lower switch valve 32 without precise engagement therewith, which tends to reduce the sealing effect of the sealing ring 33 and cause the leakage of water in practical use.

### SUMMARY OF THE PRESENT INVENTION

It is, therefore, the primary purpose of the present invention to provide a water inlet/outlet structure for a ceramic shaft of a single handled faucet, including a valve housing having a valve chamber disposed therein for a switch valve set and a valve mount to be adapted therein wherein, when hot/cold water inlet holes and a water outlet hole of a lower switch valve are overlapped on top of hot/cold water inlet passages and a water outlet passage of the valve mount respectively, grooved seats disposed at the bottom peripheries of the hot/cold water inlet holes and the water outlet hole thereof are securely coupled with higher protruded walls defining the peripheries of the hot/cold water inlet passages and the water outlet passage thereof to effect a tight seal against leakage and press downwards a sealing ring retained at a channel groove defined by the higher protruded walls and a lower stop wall of the valve mount thereof, efficiently facilitating the sealing effect of the sealing ring and ensuring the precise engagement of the lower switch valve with the valve mount thereof so as to achieve the purposes of leakage-proof as well as resistance to high water pressure and impact in practical use.

### BRIEF DESCRIPTION OF THE DRAWINGS

FIG. 1 is a perspective exploded view of a conventional water inlet/outlet structure for a ceramic shaft of a singled-handle faucet.

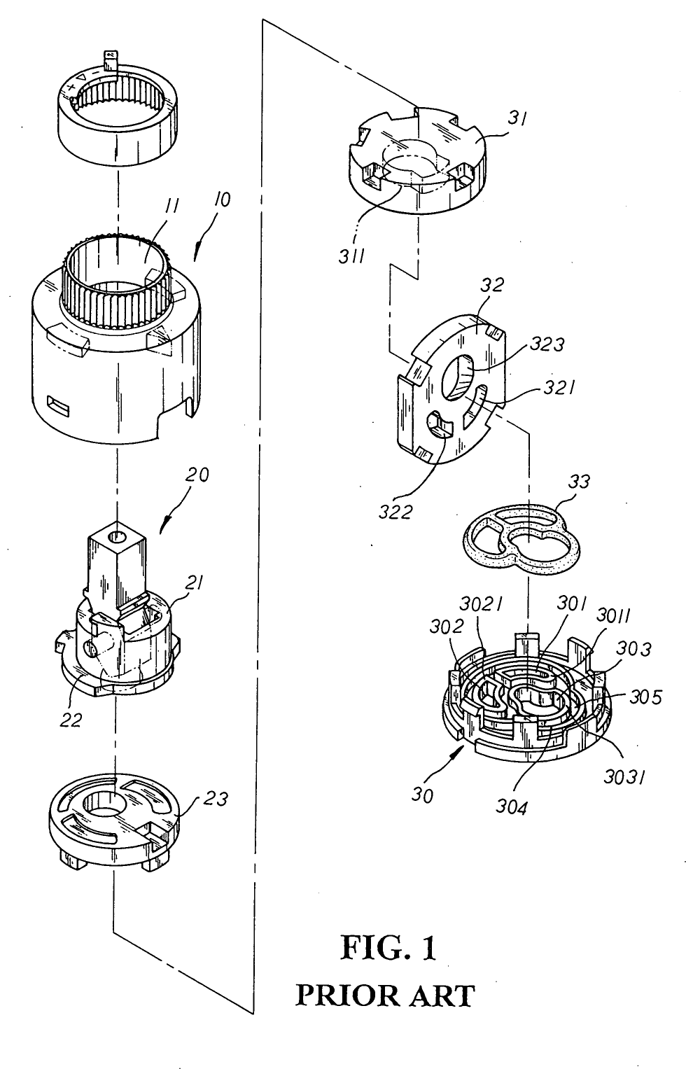

FIG. 2 is a sectional view of the conventional water inlet/outlet structure for a ceramic shaft of a singled-handle faucet in assembly.

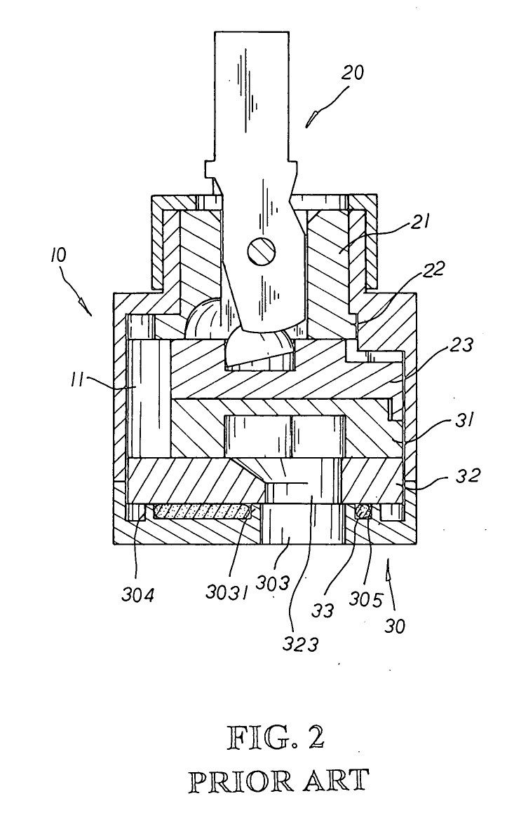

FIG. 3 is a perspective exploded view of the present invention.

FIG. 4 is a cross sectional view of the present invention in assembly.

### DETAILED DESCRIPTION OF THE PREFERRED EMBODIMENTS

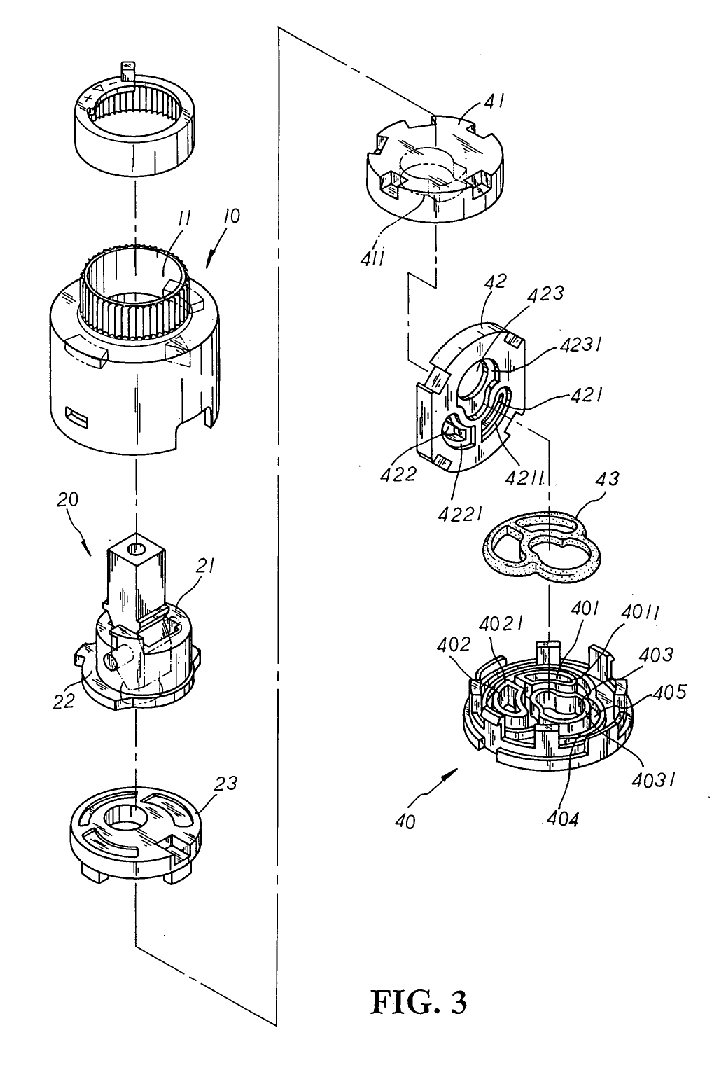

Please refer to FIG. 3. The present invention is related to a water inlet/outlet structure for a ceramic shaft of a single-handled faucet, including a valve housing 10 with a valve chamber 11 disposed at the interior thereof for a switch valve set 20, and a valve mount 40 to be adapted therein. The switch valve set 20 is made up of a control stick seat 21 disposed at the upper section thereof, and a support seat 22 and a switch valve 23 sequentially mounted at the bottom of the control stick seat 21 to be registered with the valve mount 40 thereby. The valve mount 40 is equipped with an upper switch valve 41 having a regulating recess 411 concaved at the bottom side thereon, and a lower switch valve 42 having a pair of symmetrical arc hot/cold water inlet holes 421, 422 and a water outlet hole 423 disposed thereon to be correspondingly matched to arc hot/cold water inlet passages 401, 402 and a water outlet passage 403 of the valve mount 40 thereof. The bottom peripheries of the arc hot/cold water inlet holes 421, 422 and the water outlet hole 423 of the lower switch valve 42 thereof are defined by a grooved seat 4211, 4221, 4231 respectively, and the peripheries of the arc hot/cold water inlet passages 401, 402 and the water outlet passage 403 of the valve mount 40 are respectively disposed a higher protruded wall 4011, 4021, 4031 to be engaged with the grooved seat 4211, 4221, 4231 thereby. A lower stop wall 404 is integrally formed outside the higher protruded walls 4011, 4021, 4031 thereof to define a channel groove 405 there-between for a sealing ring 43 of identical shape to be securely engaged therewith.

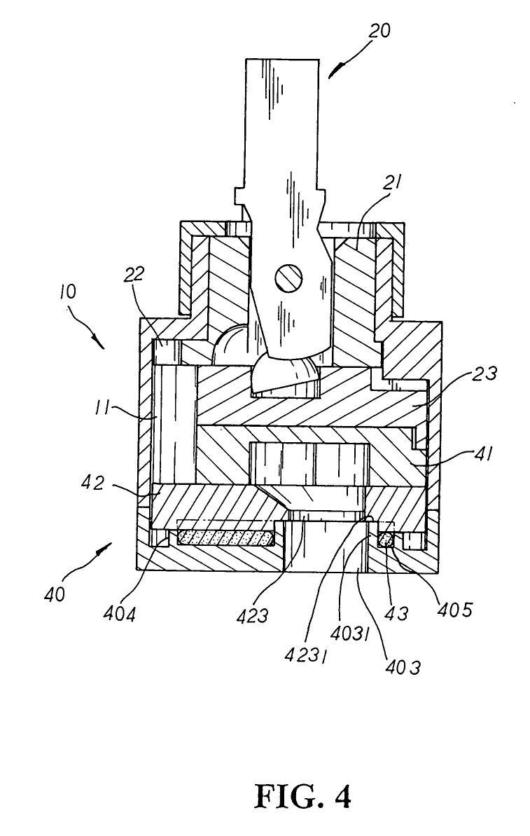

Please refer to FIG. 4. In assembly, the hot/cold water inlet holes 421, 422 and the water outlet hole 423 of the lower switch valve 42 are overlapped on top of the hot/cold water inlet passages 401, 402 and the water outlet passage 403 of the valve mount 40 respectively. The grooved seats 4211, 4221, 4231, of the hot/cold water inlet holes and water outlet hole 421, 422, 423 thereof are securely coupled with the higher protruded walls 4011, 4021, 4031, of the hot/cold water inlet passages and water outlet passage 401, 402, 403 thereof to effect tight seal against leakage. Meanwhile, the sealing ring 43 is further pressed downwards to retain securely at the channel groove 405 of the valve mount 40 therein, efficiently facilitating the sealing effect of the sealing ring 43 thereof and ensuring the precise engagement of the lower switch valve 42, with the valve mount 40 thereof so as to achieve the purposes of leakage-proof as well as resistance to high water pressure and impact in practical use.

1. A water inlet/outlet structure for a ceramic shaft of a single handled faucet, including a valve housing having a valve chamber disposed at the interior thereof for a switch valve set and a valve mount to be adapted therein wherein the switch valve set made up of a control stick seat, a support seat and a switch valve is engaged with the valve mount equipped with an upper and lower switch valves; the present invention being characterized by that;
grooved seats being disposed at the bottom peripheries of symmetrically arc hot/cold water inlet holes and a water outlet hole of the lower switch valve thereof to be registered with higher protruded walls extending at the peripheries of arc hot/cold water inlet passage and a water outlet passage of the valve mount thereof respectively wherein a lower stop wall is integrally formed outside the higher protruded walls thereof to define a channel groove there-between for a sealing ring of identical shape to be securely engaged therewith;
thus, in assembly when the hot/cold water inlet holes and the water outlet hole of the lower switch valve are overlapped on top of the hot/cold water inlet passages and the water outlet passage of the valve mount respectively, the grooved seats thereof are precisely coupled with the higher protruded walls thereof to effect a tight seal against leakage; meanwhile, the sealing ring is pressed downwards to retain securely at the channel groove of the valve mount therein, efficiently facilitating the sealing effect of the sealing ring thereof and ensuring the precise engagement of the lower switch valve with the valve mount thereof so as to achieve the purposes of leakage-proof as well as resistance to high water pressure and impact in practical use.
